(19) United States
(12) Patent Application Publication
(10) Pub. No.: US 2021/0277174 A1
(43) Pub. Date: Sep. 9, 2021

(54) EPOXY RESIN SYSTEM FOR MAKING FIBER REINFORCED COMPOSITES

(71) Applicant: Dow Global Technologies LLC, Midland, MI (US)

(72) Inventors: Luca Lotti, Correggio (IT); Timothy A. Morley, Schindellegi (CH); Nebojsa Jelic, Wangen (CH); Zeljko Sikman, Lachen (CH); Rainer Koeniger, Horgen (CH)

(21) Appl. No.: 16/611,669

(22) PCT Filed: Apr. 10, 2018
(86) PCT No.: PCT/US2018/026805

§ 371 Date: Nov. 7, 2019

Related U.S. Application Data
(60) Provisional application No. 62/522,285, filed on Jun. 20, 2017.

(51) Int. Cl. C08G 59/50; C08J 5/04; C08G 59/32; B60B 5/02; C08G 59/38; C08G 59/68

(52) U.S. Cl. CPC C08G 59/5026; C08J 5/042; C08G 59/3227; C08J 5/043; C08K 5/13; B60B 5/02; C08G 59/38; C08G 59/686; C08J 2363/00; C08J 5/046

(57) ABSTRACT

A two-component curable epoxy resin system having an epoxy component containing a unique combination of two or more epoxy resins with at least one of the epoxy resins being an epoxy novolac type resin. The composite made from such resin system exhibits high glass transition temperature.

### FIELD OF THE INVENTION

This invention relates to an epoxy based composition and processes for preparing fiber-reinforced composites.

### INTRODUCTION

Reinforced polymeric composites have several advantages over metal parts (e.g. in vehicles) including better resistance to corrosion, the ability to produce parts having complex geometries, and in some cases a superior strength-to-weight ratio. As a result the transportation industry has begun using such reinforced polymeric composites as replacement for metal structural elements such as chassis members and other structural supports.

Epoxy resin systems are sometimes used as the polymer phase in such composites. Cured epoxy resins are often quite strong and stiff, and adhere well to the reinforcement. An advantage of epoxy resin systems, compared to most thermoplastic systems, is that low molecular weight and low viscosity precursors are used as starting materials. The low viscosity is an important attribute because it allows the resin system to penetrate easily between and wet out the fibers that usually form the reinforcement during such fiber infusion processes (e.g. resin transfer molding or wet compression molding).

However, it is desired to have a resin system that has improved resistance to thermally induced aging degradation, and particularly a system that better maintains its mechanical properties.

### SUMMARY OF THE INVENTION

The present invention is based on the discovery that systems using two or more specific epoxy components show only a very modest decrease in mechanical properties after thermal aging and after under water aging (e.g. at 80 degrees C.).

Thus, according to one embodiment the invention is curable resin system comprising: i. an epoxy resin component having two or more epoxy resins wherein at least one of the two or more resins is a tetraglycidyl ether of an alkylene dianiline and the other of the two or more resins is selected from (a) a diglycidyl ether of bisphenol A, (b) a novolac resin having an average of glycidyl groups per molecule in a range of 3-4, (c) a diglycidyl ether of a linear aliphatic diol, or (d) combinations or two or more of (a)-(c) provided that the amount of component (b) is less than 50% by weight of the epoxy resin component; and ii. a hardener component which is a cycloaliphatic compound having two or more amine groups. Preferably, the system also includes a catalyst, which is most preferably combined in the harder component.

### DETAILED DESCRIPTION OF THE INVENTION

1. The Epoxy Component

In the present invention, the epoxy component contains two or more epoxy resins. The first epoxy resin is a tetraglycidyl ether of an alkylene dianiline. Preferably, this resin is a tetraglycidyl ether of a lower alkylene (1-3 carbon atoms) and most preferably of methylene dianiline. The amount of this first epoxy resin is preferably at least 20 weight percent, and preferably no more than 95 weight percent, more preferably no more than 75 weight percent, more preferably still no more than 70 weight percent, and most preferably no more than 65 weight percent based on total weight of epoxy resins.

The additional epoxy resin is selected from (a) a diglycidyl ether of a bisphenol, preferable bisphenol A or bisphenol F, (b) a novolac resin having an average of glycidyl groups per molecule in a range of 3-4, (c) a diglycidyl ether of a linear aliphatic diol, or (d) combinations or two or more of (a)-(c).

The epoxy resin (a) when used is preferably present in an amount of at least 15 weight percent, more preferably at least 20 weight percent, and no more than 80 weight percent, preferably no more than 60 weight percent based on total weight of epoxy resins.

The epoxy resin (b) is an epoxy novolac resin. U.S. Pat. No. 2,829,124 teaches the synthesis of similar epoxy novolac resin, and since then epoxy novolac resins have seen wide spread use in many different applications, including high glass transition temperature compounds. Epoxy novolac resins useful in the present invention can be generally described as methylene-bridged polyphenol compounds, in which some or all of the phenol groups are capped with an epoxy containing group, typically by reaction of the phenol groups with epichlorohydrin to produce the corresponding glycidyl ether. The phenol rings may be unsubstituted, or may contain one or more substituent groups, which, if present are preferably alkyl having up to six carbon atoms and more preferably methyl. The epoxy novolac resin useful in the present invention may have an epoxy equivalent weight (in g/eq) of at least about 150, preferably at least 156, more preferably at least 170 and no more than 300, preferably no more than 225, and most preferably no more than 190. The epoxy novolac resin may contain, for example, on average from 2 to 4, preferably 3-4, epoxide groups per molecule. Among the suitable epoxy novolac resins are those having the general structure:

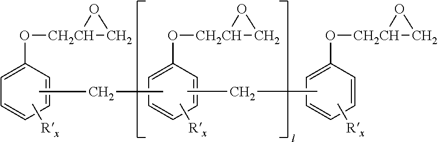

in which 1 is an integer of at least 0, preferably at least one and no more than 8, more preferably no more than 4, and most preferably no more than 3, each R′ is independently alkyl or inertly substituted alkyl, and each x is an integer from 0 to 4, preferably 0 to 2 and more preferably 0 to 1. R is preferably methyl, if present.

The novolac epoxy resin (b), when used, is present in an amount of no more than 50% by weight, more preferably no more than 40% by weight and in an amount of at least at least 5 weight percent, more preferably at least 20 weight percent based on total weight of epoxy resins.

According to one preferred embodiment the epoxy component is a ternary blend of the tetraglycidyl ether of the alkylene dianiline, epoxy resin (a) and epoxy resin (b), and the total amount of epoxy resin (a) and (b) combined is not more than 60 weight percent based on total weight of epoxy resins.

A third epoxy resin (c) may also be used in combination with the tetraglycidyl ether of the alkylene dianiline. This third resin is a diglycidyl ether of a linear aliphatic diol. The linear dialiphatic diol preferably has from 2 to 6 carbon atoms. Specifically examples include 1,4-butandiol dyglycidyl ether (BDDGE) commercially available as DER 731 from Olin Corporation, and 1,6 hexandioldiglycidyl ether (HEXDGE) commercially available as DER 734 from Olin Corporation. When this epoxy resin (c) is used it is preferably used in an amount of at least 5 weight percent and preferably no more than 20 weight percent based on total weight of epoxy resins.

The viscosity of the resin component at 80 degrees C. is less than 800 mPa-s, preferably less than 600 mPa-s. The viscosity is measured by ASTM D2196.

2. The Hardener Component

The hardener component of the present resin system is a cycloaliphatic compound containing at least two amine groups for the reaction with the epoxy resin. Typical examples of cycloaliphatic amines include isophoronediamine (CAS 2855-13-2), a blend of 2- and 4-methylcyclohexan-1,3-diamine (CAS 13897-55-7), a blend of cis- and trans-isomers of cyclohexan-1,2-diamine (often referred to as DACH, CAS 694-83-7), 4,4′-di-aminodicyclohexylmethane (CAS 1761-71-3), 1,4-cyclohexanedimethanamine (CAS 2549-93-1), and others. In one preferred embodiment, the hardener component of the present invention contains over 80 wt. % and in a more preferred embodiment over 90 wt. % of DACH, based on the total weight of the hardener component.

The hardener component and epoxy component are combined in amounts such that at least 0.80 epoxy equivalents are provided to the reaction mixture of the two components per amine hydrogen equivalent provided by the epoxy component. A preferred amount is at least 0.90 epoxy equivalents per amine hydrogen equivalent and a still more preferred amount is at least 1.00 epoxy equivalents per amine hydrogen equivalent. The epoxy component can be provided in large excess, such as up to 10 epoxy equivalents per amine hydrogen equivalent provided to the reaction mixture, but preferably there are no more than 2.00, more preferably no more than 1.25 and still more preferably no more than 1.10 epoxy equivalents provided per amine hydrogen equivalent. Thus, according to certain embodiments the amount of hardener is at least 15, more preferably at least 20 parts, and no more than 35, preferably no more than 30 parts by weight based on 100 parts of epoxy resins.

3. The Catalyst

According to a preferred embodiment present invention also provides the use of a separate catalyst, as opposed to relying solely on the hardener, to promote the polymerization reaction between the hardener and the epoxy resin. In a preferred embodiment, the catalyst is first added to the hardener component before mixing with the resin component.

The catalyst can be used in conjunction with one or more other catalysts. If such an added catalyst is used, suitable such catalysts include those described in, for example, U.S. Pat. Nos. 3,306,872, 3,341,580, 3,379,684, 3,477,990, 3,547,881, 3,637,590, 3,843,605, 3,948,855, 3,956,237, 4,048,141, 4,093,650, 4,131,633, 4,132,706, 4,171,420, 4,177,216, 4,302,574, 4,320,222, 4,358,578, 4,366,295, and 4,389,520, and WO 2008/140906, all incorporated herein by reference. Examples of suitable catalysts are molecules containing imidazole or imidazoline ring structures, such as 1-methyl-imidazole, 2-methylimidazole, 2-ethyl-4-methylimidazole, 2-phenyl imidazole, 2-methyl-2-imidazoline, 2-phenyl-2-imidazoline; tertiary amines, such as triethylamine, tripropylamine, N,N-dimethyl-1-phenylmethanamine, 2,4,6-tris(dimethylamino-methyl)phenol and tributylamine; organic phosphonium salts, such as ethyltriphenylphosphonium chloride, ethyltriphenylphosphonium bromide and ethyltriphenyl-phosphonium acetate; ammonium salts, such as benzyltrimethylammonium chloride and benzyltrimethylammonium hydroxide; various carboxylic acid compounds, and mixtures of any two or more thereof. In a preferred embodiment, the catalyst is from the class of imidazole or imidazoline compounds having a phenyl substituent, such as 2-phenylimidazole or 2-phenyl-2-imidazoline.

The resin system of the present invention typically comprises at least 0.1 weight percent, preferably at least 1 wt. %, more preferably at least 2 wt. %, and no more than 20 wt %, more preferably no more than 5 wt. % of the catalyst component, based on the total weight of the hardener component.

4. Other Components in the Resin System

Furthermore, the resin system may include optional ingredients such as impact modifiers, mold release agents, pigments, dyes, inks, preservatives (such as UV blocking agents) and antioxidants.

In other embodiments, resin compositions may also include toughening agents. Toughening agents function by forming a secondary phase within the polymer matrix. This secondary phase is rubbery and/or softer than the polymer matrix formed without the presence of toughening agents, and hence is capable of crack growth arrestment, providing improved impact toughness. Toughening agents may include polysulfones, silicon-containing elastomeric polymers, polysiloxanes, elastomeric polyurethanes, and others.

Suitable toughening agents include natural or synthetic polymers having a Tg lower than −20° C. Such synthetic polymers include natural rubber, styrene-butadiene rubber, polybutadiene rubber, isoprene rubber, polyethers such as polypropylene oxide, polytetrahydrofuran and butylene oxide-ethylene oxide block copolymers, core-shell rubbers, elastomeric polyurethane particles, mixtures of any two or more of the foregoing, and the like. The rubbers are preferably present in the form of small particles that become dispersed in the polymer phase of the resin system. The rubber particles can be dispersed within the epoxy resin and/or within the hardener.

It is generally preferred to cure the epoxy resin and the hardener mixture in the presence of an internal mold release agent. Such an internal mold release agent may constitute up to 5%, more preferably up to about 1% of the total weight of the resin composition. Suitable internal mold release agents are well known and commercially available, including those marketed as Marbalease™ by Rexco-USA, Mold-Wiz™ by Axel Plastics Research Laboratories, Inc., Chemlease™ by Chem-Trend, PAT™ by Wilrtz GmbH, Waterworks Aerospace Release by Zyvax and Kantstik™ by Specialty Products Co. In addition to (or instead of) adding the internal mold release agent during mixing, it is also possible to combine such an internal mold release agent into the epoxy component and/or the hardener component before the epoxy component and the hardener component are brought together.

Suitable particulate fillers have an aspect ratio of less than 5 and preferably less than 2, and do not melt or thermally degrade under the conditions of the curing reaction. Suitable fillers include, for example, pigments, glass flakes, glass microspheres, aramid particles, carbon black, carbon nanotubes, various clays such as montmorillonite, halloysite, phillipsite, and other mineral fillers such as wollastonite, talc, mica, titanium dioxide, barium sulfate, calcium carbonate, calcium silicate, flint powder, carborundum, molybdenum silicate, sand, and the like. Some fillers are somewhat electro-conductive, and their presence in the composite can increase the electro-conductivity of the composite itself. In some applications, notably automotive applications, it is preferred that the composite is sufficiently electro-conductive that coatings can be applied to the composite using E-coat methods, in which an electrical charge is applied to the composite and the coating becomes electrostatically attracted to the composite. Conductive fillers of this type include metal particles (such as aluminum and copper), graphene carbon black, carbon nanotubes, graphite and the like.

5. The Resin System

The hardener component and epoxy component are combined in amounts as set forth above.

In some embodiments, the present resin system has, when cured at one temperature comprised between 60 and 180° C., preferably 80 to 150 C, a gel time of at least 15 seconds, at least 20 seconds, or preferably at least 30 seconds, and a demold time no greater than 360 seconds, preferably no greater than 300 seconds and still more preferably no greater than 240 seconds.

Thermoset resins are formed from the resin system of the invention by mixing the epoxy component, the hardener component, and, preferably, the catalysts and any desire optional components at proportions as described above, and curing the resulting mixture. Either or all of the components can be preheated if desired before they are mixed with each other. Preferably the epoxy component and the hardener component are combined immediately prior to or simultaneously with molding of the article to be formed. It is generally necessary to heat the mixture to an elevated temperature to obtain a rapid cure.

In a molding process such as the process for making molded composites, the curable reaction mixture is introduced into a mold, which may be, together with any reinforcing fibers and/or inserts as may be contained in the mold, preheated. The resin system of this invention is particularly suitable for fiber infusion to form composites e.g. by resin transfer molding or wet compression molding.

The resin system is used to form composites formed by resin transfer molding or wet compression molding with a fiber composition selected from continuous fiber materials, non-woven fiber materials, woven fiber materials, long strand fiber materials (e.g., from 10 to 2000 mm), a mat made of randomly-aligned fibers having different lengths (from 5 to 200 mm) or stack of mats, and combinations thereof. The fiber may be glass fibers, ceramic givers, carbon fibers, aramid fibers, acrylonitrile fibers, or combinations thereof. The amount of the fiber to resin system is in weight ratios of 40 to 80 wt.-%, preferably 55 to 75 wt.-%.

The glass transition temperature of the resulting composite by ASTM D5023 (2015) is preferably at least 200, more preferably 215 degrees C.

The tensile strength of the cured resin system (neat, i.e. not as a composite) is greater 45 MPa with a flexural strength greater than 90 MPa.

6. Thermal Post Cure

The post cure thermal process provides a crosslinking of the macromolecules outside of the mold used for the making of the composite. The advantage of carrying out a similar curing outside of the mold is related to productivity, and with respect to a possible room-temperature ageing, the advantage includes the raise of the glass transition temperature to values well above the initial Tg as measured on the compound soon after the demolding.

In terms of productivity and with respect to a possible crosslinking operated inside the mold, including an external post cure protocol (e.g., in an oven), the mold is used for a very short time. Thus, many demolded pieces may successively cure together, in a common oven, while production with the mold continues. A pre-requirement for operating a high temperature post curing is that the pieces are removed from the mold without any appreciable deformation, i.e., after a pre-determined suitable demold time.

On the other side, crosslinking must be operated at a certain temperature which, in principle, should be higher than the glass transition temperature of the polymer at demold. In fact, the kinetic of crosslinking will be favored by a certain mobility of macromolecular chains; a similar situation of mobile macromolecular chains is obtained when the polymer is heated above its Tg. If a curing is carried out below the Tg, instead, only minor improvements of the final Tg are observed, if none at all.

The following examples are provided to illustrate the invention, but not limit the scope thereof. All parts and percentages are by weight unless otherwise indicated.

### Examples

Resin system formulations were made by combining the stated epoxy resins in the amounts recited in Table 1a to form the epoxy component. Viscosity of the resin component is measured according to ASTM D2196, with a viscometer. The purpose of the viscosity measurement of the pure resin is to see if processing is possible with common epoxy metering machines. The 1,2-diaminocyclohexane hardeners were combined with the recited catalysts (no catalyst for hardener 3).

Gel time and Tack-free time were determined as follows: A mix of the epoxy component and hardener component is blended with a spatula in a cup and poured onto a hot plate thermostated at 135° C. and pre-treated with a mold release agent (Muench-Chemie Mikon W-31+). The gel time is defined as the time at which repeated pulling of the spatula through the poured liquid is not followed anymore by liquid re-composing a horizontal surface, that is, liquid not coming anymore together behind the spatula being pulled through the liquid itself.

Neat resin specimens for the various tests were prepared by pouring the reactive mixture, prepared again by blending a weighted amount of the components in a cup with a spatula, in a 2 mm thick mold thermostated at 135° C. and pre-treated with a mold release agent (Muench-Chemie Mikon W-31+). After 5 minutes from the pouring of an appropriate amount of the reacting mixture (i.e. completely filling the mold), the mold is open and a 2 mm thick plaque of unreinforced resin is removed. These samples were tested for Tensile Strength and Tensile Modulus according to EN 527-1 and Flexural Modulus according to ASTM D790.

Unidirectional carbon composites are prepared with the Wet Compression technique. The reactive mixture is poured atop a carbon fiber fabric (Dow Aksa A42) unidirectional, 6 plies placed on a table; then, the carbon fiber fabric wet with the reactive mixture is transferred to an open, thermostated mold (540×290 mm×2 mm thickness, temperature 135° C.) located into a press able to deliver 200 bars of pressure. After the placement of the fabric on the bottom of the mold, the press is slowly closed leaving 2 mm of final thickness; then, the material is let cure for five minutes inside the press. After five minutes, the press is open and a composite part is removed. The amount of reacting mixture is tuned with respect to the fiber weight in order to have an indicative final fiber weight fraction in the composite of roughly 61 wt.-%. These samples were tested for Interlaminar Shear Strength according to EN ISO 14130 and glass transition temperature according to ASMT D5023. The results are shown in Table 1b.

Certain of the samples were tested for hot water aging. Hot water (80° C.) aging for neat resin samples. Two specimens of neat resin sample being 60×12×2 mm in dimensions are used for this test; after 24 h of pre-conditioning at 110° C. plus 24 h of cooldown to room temperature in a desiccator, the first sample is tested for Tg via DMA, while the other is soak into hot water (80° C.) and left in an oven at that temperature for 60 days. Weight is checked daily. At the end of 60 days, the Tg is checked.

Hot water (80° C.) aging for carbon composite parts. Two DMA specimens of carbon composite part being 60×12×2 mm in dimensions and twelve ILSS (EN 14130) specimens being 20×10×2 mm in dimensions are used. Six ILSS and one DMA specimen are tested before the aging, and the remaining six ILSS and one DMA specimens are tested after soaking in hot water (80° C.) for 21 days.

The composite samples were tested by DMTA analysis according to ASTM 5023 before and after thermal cycling to determine the effect of heat on Tg. The thermal cycling is carried out by exposing the composite parts to high temperatures (specifically, 230° C.). 20 cycles are performed, and this simulates the environmental conditions of a composite part being subjected to a repeated heating. Composite plates, of the dimension cited before (540×290×2 mm) are put on the bottom of a pre-heated oven, so that the composite surface touches entirely the bottom part of the oven, which is in steel. The temperature of the composite on the surface not in touch with the bottom of the oven has been measured in a first experiment by means of a thermocouple reader equipped with a K-type thermocouple placed on the upper face of the composite. The temperature of the plate reached stable (225±5°) C. within 2 minutes; after 15 minutes of exposure, the oven is open and composite plate removed and let cool down on a wooden table. Temperature reaches (30±5°) C. within 10 minutes.

TABLE 1a

| | | | | | | Hardener - (amount in parts by weight) | | | | | |
|---|---|---|---|---|---|---|---|---|---|---|---|
| | | | | | | 1,2,-diamino- | 1,2,-diamino- | | | | Post |
| | | | | | | cyclohexane | cyclohexane with | 1,2,-diamino- | Gel Time | Post | Cure |
| | Epoxy Component (amounts in parts by weight) | | | | | with 5 wt % 2- | 3.45 wt % of 2- | cyclohexane | (s, on hot | curing | temper- |
| Example | | Resin | Resin | Resin | Resin | phenylimid- | phenylimid- | with no | plate at | duration | ature |
| Number | TGMDA | (a) | (b) | (c)1 | (c)2 | azole | azole | catalyst | 135 C.) | (min) | (C.) |
| Comparative | — | 60 | 40 | — | — | 17 | — | — | 47 | 30 | 200 |
| Example 1 | | | | | | | | | | | |
| Comparative | — | 40 | 60 | — | — | 17 | — | — | 32 | — | — |
| Example 2 | | | | | | | | | | | |
| Comparative | — | — | 100 | — | — | — | — | 16.2 | 48 | 60 | 215 |
| Example 3 | | | | | | | | | | | |
| Comparative | 100 | — | — | — | — | — | 26.1 | — | 75 | 60 | 215 |
| Example 4 | | | | | | | | | | | |
| Comparative | 20 | 20 | 60 | — | — | — | 18.4 | — | 68 | 60 | 215 |
| Example 5 | | | | | | | | | | | |
| Comparative | Composition of Example 5 of U.S. Pat. No. 8,742,018 | | | | | | | | 98 (hot | — | — |
| Example 6 | | | | | | | | | plate at | | |
| | | | | | | | | | 160 C.) | | |
| 1 | 60 | 40 | — | — | — | — | 22.2 | — | 88 | 60 | 215 |
| 2 | 60 | — | 40 | — | — | — | 22.3 | — | 72 | 60 | 215 |
| 3 | 20 | 60 | 20 | — | — | — | 18.3 | — | 84 | 60 | 215 |
| 4 | 60 | 20 | 20 | — | — | — | 22.2 | — | 71 | 60 | 215 |
| 5 | 40 | 30 | 30 | — | — | — | 20.3 | — | 70 | 60 | 215 |
| 6 | 87 | — | — | 13 | — | — | 26.1 | — | 82 | 60 | 215 |
| 7 | 93.5 | — | — | 6.5 | — | — | 26.1 | — | 80 | 60 | 215 |
| 8 | 87 | — | — | — | 13 | — | 25.2 | — | 85 | 60 | 215 |
| 9 | 93.5 | — | — | — | 6.5 | — | 25.6 | — | 76 | 60 | 215 |

TGMDA—tetraglycidyl diamino diphenylmethane sold as Araldite MY 721 from Huntsman
Resin (a) is DER 330 from Olin Corp, - diglycidyl ether of bisphenol A
Resin (b) is DEN 439 from Olin Corp. = 3/6 functional glydicdyl ether novolac resin
Resin (c)1 is 1,4 butanediol diglycidyl ether sold as DER 731 from Olin Corp.
Resin (c)2 is 1,6-hexandiol diglydicyl ether sold as DER 734 from Olin Corp.

TABLE 1b

| | | | | | | | Composite |
|---|---|---|---|---|---|---|---|
| | Epoxy | Neat Resin | | | | | Interlaminar |
| | component | Tensile | Tensile | Flexural | Weight increase | Tg after 60 | Shear Strength |
| Example | Viscosity* | Strength*** | Modulus*** | Strength+ | after 60 days hot | days hot water | (no aging)++ |
| Number | (mPa-s) | (MPa) | (MPa) | (MPa) | water aging (%) | aging (C.) | (MPa) |
| Comparative | 347 | 52 | 3060 | 84 | — | — | 78 |
| Example 1 | | | | | | | |
| Comparative | 845 | — | — | — | — | — | — |
| Example 2 | | | | | | | |
| Comparative | 4480 | 44 | 3220 | 84 | — | — | 78 |
| Example 3 | | | | | | | |
| Comparative | 353 | 35 | 3700 | 127 | 4.7 | 120 | 73 |
| Example 4 | | | | | | | |
| Comparative | 446 | 32 | 3300 | 81 | — | — | 77 |
| Example 5 | | | | | | | |
| Comparative | — | — | — | — | 6 | 160 and 196 | 67 |
| Example 6 | | | | | | | |
| 1 | 136 | 61 | 3110 | 113 | 3.8 | 122 | 77 |
| 2 | 433 | 47 | 3620 | 93 | — | — | 78 |
| 3 | 121 | 65 | 3210 | 110 | — | — | 74 |
| 4 | 317 | 49 | 3510 | 110 | 4 | 123 | 76 |
| 5 | 242 | 49 | 3190 | 94 | — | — | 75 |
| 6 | 105 | 62 | 2870 | 101 | 4.5 | 118 | 83 |
| 7 | ** | 55 | 3580 | 140 | — | — | 69 |
| 8 | ** | 68 | 3707 | 129 | — | — | 73 |
| 9 | ** | 56 | 3735 | 140 | — | — | 70 |

| | Composite | | | | |
|---|---|---|---|---|---|
| | | | Tg+++ | Tg+++ | |
| | Interlaminar Shear | | after 21 | after | Change in Tg after |
| | Strength (after 21 | | days hot | thermal | thermal cycling |
| Example | days hot water aging)++ | | water aging | cycling | (i.e. Tg after thermal |
| Number | (MPa) | Tg (C.)+++ | (C.) | (C.) | cycling - initial Tg) |
| Comparative | — | 195 | — | 179 | −16 |
| Example 1 | | | | | |
| Comparative | — | — | — | — | — |
| Example 2 | | | | | |
| Comparative | — | 222 | — | 220 | −2 |
| Example 3 | | | | | |
| Comparative | 75 | 267 | 243 | 251 | −16 |
| Example 4 | | | | | |
| Comparative | — | 217 | — | 212 | −5 |
| Example 5 | | | | | |
| Comparative | — | 224 | 144 | 159 | −65 |
| Example 6 | | | | | |
| 1 | 76 | 203 | 186 | 210 | +7 |
| 2 | — | 246 | — | 238 | −8 |
| 3 | — | 204 | — | 201 | −. |
| 4 | 76 | 234 | 194 | 212 | −22 |
| 5 | — | 219 | — | 210 | −9 |
| 6 | — | 240 | — | 208 | −32 |
| 7 | — | 249 | — | 246 | −3 |
| 8 | — | 239 | — | 214 | −25 |
| 9 | — | 248 | — | 246 | −2 |

at 80 C. by ASTM D2196
**less than miscosity of TGMDA which is 353
***EN 527-1
+ASTM D790
++EN ISO 14130
+++ASTM D5023

1) A curable resin system comprising:
i. an epoxy resin component having two or more epoxy resins wherein at least one of the two or more resins is a tetraglycidyl ether of an alkylene dianiline and the other of the two or more resins is selected from (a) a diglycidyl ether of bisphenol A or bisphenol F, (b) a novolac resin having an average of glycidyl groups per molecule in a range of more than 2 to up to 4, (c) a diglycidyl ether of a linear aliphatic diol, or (d) combinations or two or more of (a)-(c) provided that the amount of component (b) is less than 50% by weight of the epoxy resin component;
ii. a hardener component which is a cycloaliphatic compound having two or more amine groups.

2) The curable resin system of claim 1 wherein the composition further comprises a catalyst.

3) The curable resin system of claim 2 wherein the catalyst comprises at least one of imidazole or a compound with an imidazoline ring structure and the catalyst is part of the hardener component.

4) The curable resin system of claim 1 wherein the epoxy resin component contains the tetraglycidyl ether of an alkylene dianiline in an amount of from 20-95 weight percent based on total weight of the epoxy resin component.

5) The curable resin system of claim 2 wherein the catalyst is present in amounts of 0.1-20 weight percent based on total combined weight of the hardener and catalyst.

6) The curable resin system of claim 1 wherein the epoxy resin component comprises from 20 to 70 weight percent of the tetraglycidyl ether of an alkylene dianiline, from 5 to 60 weight percent of the diglycidyl ether of bisphenol A, and from 5 to 50 weight percent of the novolac resin having an average content ranging from 3 to 4 glycidyl groups per molecule based on total weight of the epoxy resin component.

7) The curable resin system of claim 1 wherein the epoxy resin component comprises from 80 to 95 weight percent of the tetraglycidyl ether of an alkylene dianiline, and 5 to 20 weight percent of a diglycidyl ether of a linear aliphatic diol.

8) The curable resin system of claim 1 wherein the diglycidyl ether of a linear aliphatic diol is a n-propandiol diglycidyl ether, a n-butanediol diglycidyl ether, a n-pentanediol diglycidyl ether or a n-hexanediol diglycidyl ether.

9) The curable resin system of claim 1 wherein the tetraglycidyl ether of an alkylene dianiline is the tetraglycidyl ether of diamino diphenylmethane.

10) The curable resin system of claim 1 wherein the hardener component is 1,2-diamino cyclohexane.

11) The curable resin system of claim 1 having a gelation time of less than 90 seconds when the components are metered via an epoxy mixing machine and at a mold temperature of 135° C.

12) The curable resin system of claim 1 in which the epoxy resin blend displays a viscosity of less than 800 mPa·s at 80° C.

13) The curable resin system of claim 1 wherein the composition further comprises one or more impact modifiers, internal mold release agents, pigments or antioxidants.

14) The curable resin system of any of claim 1 where (a) is bisphenol A.

15) A fiber reinforced composite comprising the curable resin system of claim 1 and a fiber composition, wherein the fiber composition is a continuous fiber material, a non-woven fiber material, a mat or a stack of two or more mats, or a material comprising both continuous and discrete fibers and wherein the fiber composition is chosen from the group consisting of carbon fiber, glass fiber, ceramic fiber, acrylonitrile fiber, aramid fiber, or their admixtures.

16) The fiber reinforced composite of claim 15 having a glass transition onset greater than or equal to 200° C.

17) A car wheel rim made via resin transfer molding or wet compression molding with the fiber reinforced composite of claim 15.
